(19) United States
(12) Patent Application Publication
(10) Pub. No.: US 2004/0059659 A1
(43) Pub. Date: Mar. 25, 2004

(54) Map based lottery ticket sales and marketing analysis system and method

(76) Inventors: Aman Safaei, Pleasantville, NY (US); Wen Rong Wu, Bayside, NY (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/660,307

(22) Filed: Sep. 10, 2003

Related U.S. Application Data
(60) Provisional application No. 60/410,659, filed on Sep. 13, 2002.
(60) Provisional application No. 60/410,658, filed on Sep. 13, 2002.

(51) Int. Cl. G06F 17/60

(52) U.S. Cl. 705/35

(57) ABSTRACT

In some embodiments, a computer-implemented method for processing lottery sales data comprises: assigning unique identifiers to a plurality of lottery retailers, where the unique identifiers indicate types of lottery games sold by respective lottery retailers from the plurality of lottery retailers; and identifying on a map display on a computer using the unique identifies respective locations of lottery retailers from the plurality of lottery retailers. In some embodiments, a computer-implemented method for processing lottery sales data comprises: identifying on a map display on a computer a location of at least one lottery retailer from a plurality of lottery retailers; and identifying on said map display lottery sales data respective to the at least one lottery retailer representative of lottery sales by said at least one lottery retailer for a selected period of time.

This application claims the benefit of U.S. Provisional Application No. 60/410,659, filed Sep. 13, 2002 and U.S. Provisional Application No. 60/410,658, also filed Sep. 13, 2002.

### FIELD OF THE INVENTION

The present invention relates generally to computer networks and the like, and more particularly to systems and methods for sales and marketing analysis, particularly to sales and marketing analysis for lottery tickets.

### BACKGROUND OF THE INVENTION

Lottery sales are an important source of revenue for many states. However, the teachings of the prior art do not provide tools that lottery administrators can use to easily evaluate sales data relevant to instant and on-line lottery ticket sales by lottery retailers, particularly for use in the evaluation of retailer placement and performance or for use in making marketing decisions.

### SUMMARY OF THE INVENTION

In some embodiments, a computer-implemented method for processing lottery sales data comprises: assigning unique identifiers to a plurality of lottery retailers where the unique identifiers indicate types of lottery games sold by respective lottery retailers from the plurality of lottery retailers; and identifying on a map display on a computer using the unique identifiers respective locations of lottery retailers from the plurality of lottery retailers.

In some embodiments, a computer-implemented method for processing lottery sales data comprises: identifying on a map display on a computer a location of at least one lottery retailer from a plurality of lottery retailers; and identifying on said map display lottery sales data respective to the at least one lottery retailer representative of lottery sales by said at least one lottery retailer for a selected period of time.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is a stylized overview of a system of interconnected computer networks;

FIG. 2 shows a map display of a portion of North America displayed by the system of FIG. 1;

FIG. 3 shows a display of a spreadsheet file including sales data for lottery retailers;

FIG. 4 shows a display of a mapping configuration interface displayed to a user by the system of FIG. 1;

FIG. 5 shows retailers identified in a map display of Georgia displayed by the system of FIG. 1;

FIGS. 6 and 7 show zoomed map displays of the display of FIG. 5;

FIGS. 8 and 9 show additional mapping configuration interfaces displayed by the system of FIG. 1 for identifying demographic data and sales data on a map display displayed by the system of FIG. 1; and

FIGS. 10 and 11 show zoomed map displays identifying retailer location, demographic data and sales data on a map display displayed by the system of FIG. 1.

### DETAILED DESCRIPTION

U.S. Provisional Application Nos. 60/410,659 and 60/410,658, both filed Sep. 13, 2003, are incorporated by reference herein in their entirety.

The Internet is a worldwide system of computer networks—a network of networks in which a user at one computer can obtain information from any other computer and communicate with users of other computers. The most widely used part of the Internet is the World Wide Web (often-abbreviated “WWW” or called “the Web”). One of the most outstanding features of the Web is its use of hypertext, which is a method of cross-referencing. In most Web sites, certain words or phrases appear in text of a different color than the surrounding text. This text is often also underlined. Sometimes, there are hot spots, such as buttons, images or portions of images that are “clickable.” Clicking on hypertext or a hot spot causes the downloading of another web page via a protocol such as hypertext transport protocol (HTTP). Using the Web provides access to millions of pages of information. Web “surfing” is done with a Web browser, the most popular of which presently are Netscape Navigator and Microsoft Internet Explorer. The appearance of a particular website may vary slightly depending on the particular browser used. Recent versions of browsers have “plug-ins,” which provide animation, virtual reality, sound and music. Interpreted programs (e.g., applets) may be run within the browser.

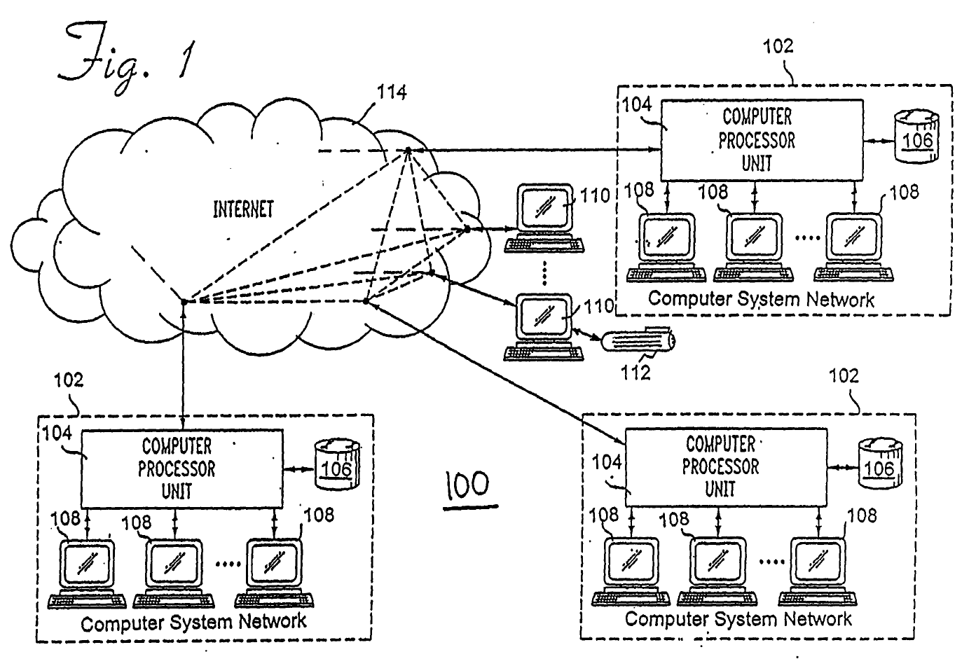

FIG. 1 shows a system 100 of interconnected computer system networks 102. Each computer system network 102 contains a corresponding local computer processor unit 104, which is coupled to a corresponding local data storage unit 106, and local network user terminals 108. A computer system network 102 may be a local area network (LAN) or part of a wide area network (WAN), for example. The local computer processor units 104 are selectively coupled to a plurality of user devices 110 through Internet 114 described above. Each of the plurality of user devices 110 and local user terminals 108 (collectively, user terminals) may have various devices connected to their local computer systems, such as scanners, barcode readers, printers, finger print scanners, mouse devices, and other interface devices 112.

A user device 110, programmed with a Web browser or other software, locates and selects (such as by clicking with a mouse) a particular Web page, the content of which is located on the local data storage unit 106 of a computer system network 102, in order to access the content of the Web page. The Web page may contain links to other computer systems and other Web pages.

The user device 110 may be a microprocessor-based computer terminal, a pager that can communicate through the Internet using the Internet Protocol (IP), a Kiosk with Internet access, a connected personal digital assistant or PDA (e.g., a PALM device manufactured by Palm, Inc. or IPAQ device available from Compaq) or other device capable of interactive network communications, such as an electronic personal planner. User device 110 may also be a wireless device, such as a hand-held unit (e.g., cellular telephone) that connects to and communicates through the Internet using the wireless access protocol (WAP).

The system and method described herein may be implemented by utilizing at least a part of the system 100 described above in connection with FIG. 1. It should be apparent to one of ordinary skill that the system may be incorporated in a LAN, in a WAN, or through an Internet 114 based approach, such as through a hosted or non-hosted application service, or through a combination thereof. The functionality of the method may be programmed and executed by at least one computer processor unit 104, with necessary data and graphical interface pages as described below stored in and retrieved from a data storage unit 106. A user can access this functionality using a user device 110 or computer terminal 108.

In some embodiments, the system and method allow state lottery administrators, particularly their sales representatives and marketing agents, or other interested parties, to easily evaluate sales data relevant to lottery ticket sales—both online and instant ticket sales—made by lottery agents or retailers (hereinafter, “retailers”). The term “on-line” lottery ticket means a ticket usable in lottery games sold most prominently at convenience stores, for example, where a lottery retailer uses a lottery terminal connected to a backend lottery processor via a communications network to issue lottery tickets to customers. Such games are distinguishable from so called “instant” or “scratch-off” lottery tickets. Examples of on-line games include the ubiquitous “pick 3,” “pick 4” and “pick 6” games. These games are distinguishable from so called “instant” or “scratch-off” lottery tickets. The system and method described herein may be implemented with respect to on-line lottery ticket sales, instant ticket lottery sales, or any other lottery game. In certain embodiments, the system described below provides a powerful tool for lottery administrators to examine and evaluate sales data for all or some of the retailers and utilize the data in various decision making processes, such as franchise location and allocation and lottery game marketing decisions.

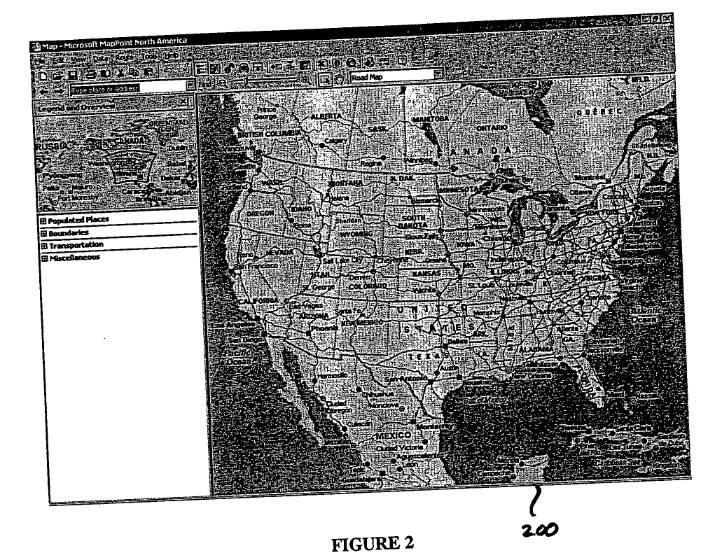

Described in connection with FIGS. 2-11 are a map based sales and marketing analysis system and method. As mentioned, the system may be client based and may be implemented using the MICROSOFT® MAPPOINT® software package available from Microsoft Corporation of Redmond, Wash. A MapPoint display 200 of a geographic region—North America—is shown in FIG. 2. Although described herein in connection with the MapPoint software package, the system and method are by no means limited thereto. Rather, the system and method can utilize other mapping products as long as retailer locations, sales figures and/or population and demographic data, and other data, such as data identifying possible candidates for becoming a lottery retailer, and the like can be mapped or otherwise identified on a map display.

In some embodiments, sales data representing lottery ticket sales of individual lottery game types are provided to a user terminal 108 or 110 from a processor 104 through the Internet. The data may be packaged as a Microsoft Excel file, for example. The sales data may be periodically obtained by processor 104 from a central lottery processor, which logs all lottery transactions for ticket sales made through lottery terminals at retailers. Processor 104 preferably also has access to sales data for instant ticket games and other lottery games.

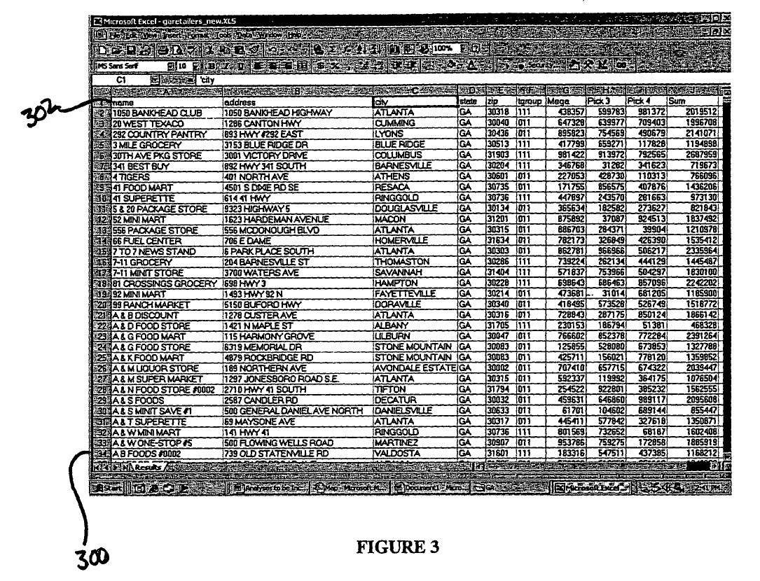

As shown by the display 300 of an Excel file in FIG. 3, the sales data preferably include (as shown by column headings 302) the name of each lottery retailer, the address of each lottery retailer including state, city, zip code and street address, total sales by each retailer for a specific time period, and sales figures for specific lottery game types (e.g., the sales figures for instant games, “Pick 3,” “Pick 4,” etc.). The display 300 of FIG. 3 shows data for retailers in Georgia. Each retailer is also associated with a data code (entitled “tgroup” for purposes of this disclosure) that identifies what kind of tickets the retailer sells. For example, data code “011” as shown corresponds to retailers of online and instant tickets only, and data code 111 corresponds to retailers of quick cash, instant ticket, and on-line tickets sales. Data code “000” represents retailer stores that do not yet carry any type of lottery game.

The user of the system may be provided the option of identifying what sales data to download. For example, the user may only be interested in retailers selling “Pick 3” tickets in a specific county covering a finite number of zip codes. The user can then define the required data through an appropriate graphical user interface (GUI) and the selected data are then downloaded as, for example, a customized Excel file, rather than downloading extraneous sales information. In one embodiment, search capabilities as described in the copending patent application Ser. No. ______ to Aman Safaei and Wen Rong Wu, entitled “On-Line Sales Analysis System and Method” and filed on the same date hereas, may be utilized to parse the sales data to identify retailers sharing specific characteristics. For example, only retailers meeting certain sales thresholds may be identified, or retailers having specific names. The sales data may be parsed to identify any specific subset of retailers, and the sales data associated with those retailers may be packaged as an Excel spreadsheet, for example. The data may then be imported for use by the mapping software. This may be an effective means of limiting the amount of data that must be imported. Alternatively, comprehensive data files may be imported and the mapping configuration tool (e.g., “Data Mapping Wizard feature”) as described below may be used to parse the data and retailers for identification on a map display.

A user's access to the sales data may be limited according to, for example, geographic region. A sales representative from Georgia may have access only to sales data for Georgia lottery games or retailers. Access rights may be defined by any access rights means, such as a username and password associated with access rights to specific data.

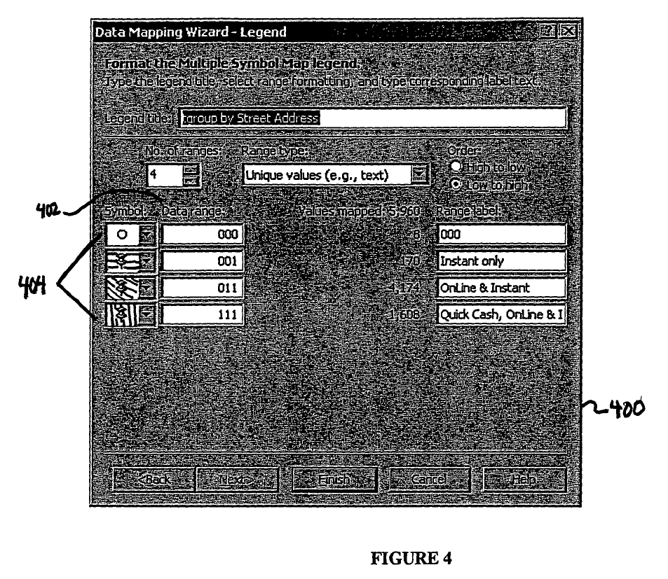

In some embodiments, sales data are identified on a map display using the MapPoint software package (or other mapping software) according to user defined criteria, more specifically using the “Data Mapping Wizard” feature of the software package. Referring to FIG. 4, a Data Mapping Wizard display 400 is shown. The display 400 enables the user to assign unique identifiers to groups of lottery retailers sharing some characteristic(s). For example, as shown in FIG. 4, four different data ranges 402 are established, each of which is identified with a different mapping symbol 404 (e.g., a different symbol and/or different colored symbol) and corresponding to the data codes described above (FIG. 3). Examples of mapping symbols 404 include tack icons having different colors (although shown in black and white in FIG. 4) that represent, respectively, (a) retailers that only sell Instant tickets, (b) retailers that sell on-line and instant tickets, and (c) retailers that sell quick cash, on-line and instant tickets or another combination. The number of entries from the imported sales data within each data range is also shown. For example, the sales data indicate that 4,174 retailers share data code 011, indicating that they sell on-line and instant tickets. The locations of retailers are then identified on a map display as described below.

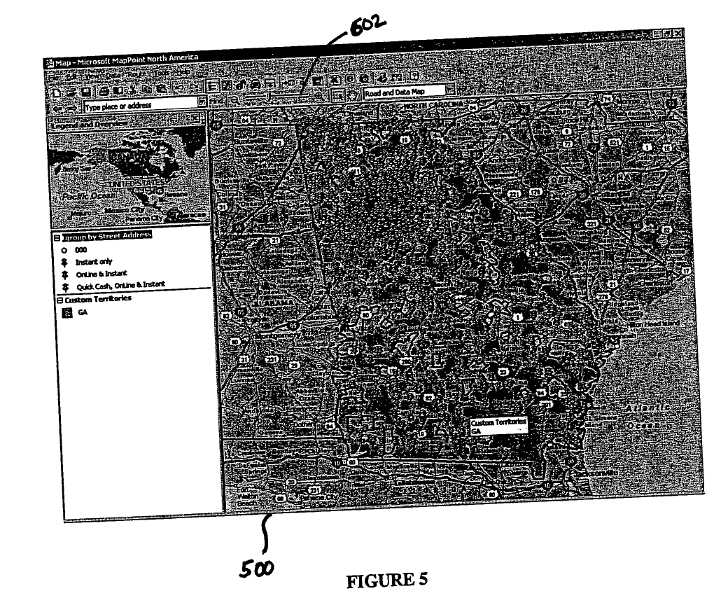

After importing the sales data to the mapping software (e.g., MapPoint software) and configuring the mapping function as described in FIG. 4, the individual retailers are identified on a map display by their respective mapping symbols in a territory defined by the user. For example, the user can instruct (through an interface not shown) the software application to map the retailers according to the configuration of FIG. 4 that are located in Georgia, as identified by the sales data shown in FIG. 3. FIG. 5 shows retailers identified on a map display 500 of Georgia and identified by their respective symbols, as defined above (FIG. 4).

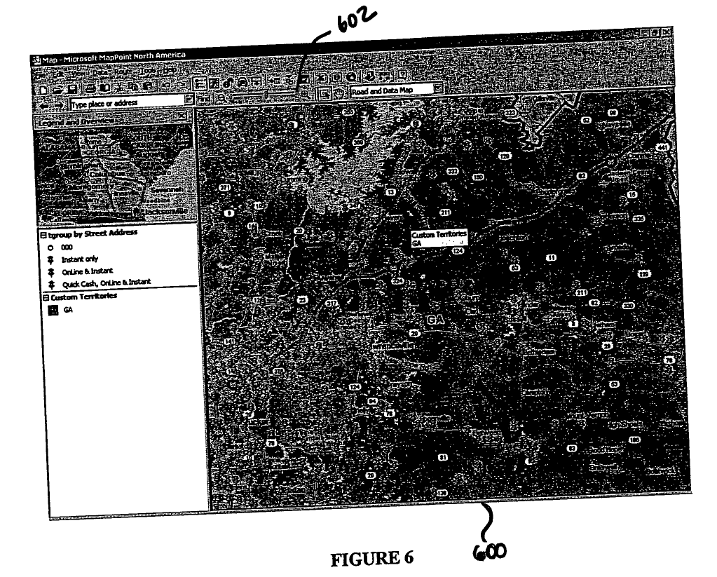

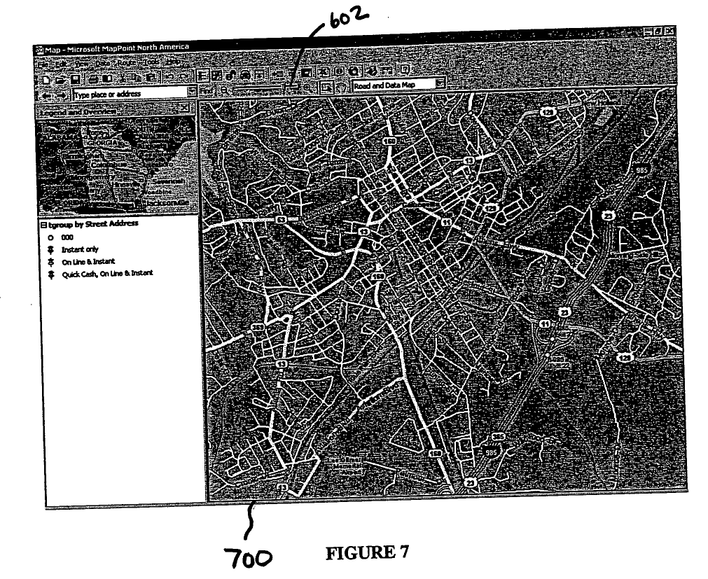

Referring to the map display 600 of FIG. 6, the user can use the mapping software's “zoom” feature 602 to focus in on a specific region of the territory displayed in the display 500 of FIG. 5. Again, the retailers within that region are indicated according to their corresponding mapping symbol (e.g., its respective colored tack icon as defined in FIG. 4). FIG. 7 illustrates a display 700 depicting that the zoom feature 602 can be used to zoom down to the street level to better view specific retailer locations.

In some embodiments, the mapping software (such as the MapPoint software package) already includes or has access to demographic data, such as census data. The demographic data may include information such as population by region, such as by zip code, information on the educational background of the population, information on the household income of the population, and housing unit information, i.e., houses per unit area. Other data may also be imported for use by the mapping software. This second set of data may include updated census data purchased or otherwise obtained from a vendor or other source. Other information may include data identifying hospital locations, hotel locations, convenience mart locations or any other data that may help in evaluating sales data and that can be geographically associated and identified on a map display. The mapping configuration (e.g., the “Data Mapping Wizard” feature of the MapPoint software package) described above in connection with FIG. 4 may be utilized to configure the identification of this additional data on a map display.

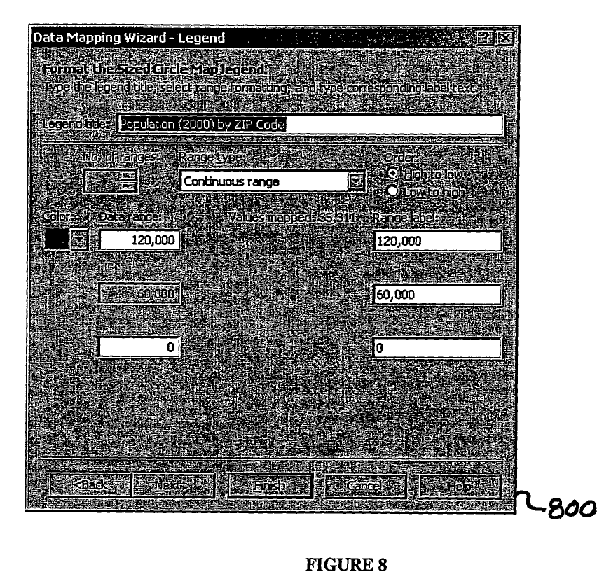

As shown in the configuration display 800 FIG. 8, for example, the Data Mapping Wizard function of MapPoint is used to configure the mapping of population statistics on a map display. The user can define how the population data, either from MapPoint or imported from a secondary source, is displayed. For example, a color scheme can be used to identify population densities. A population density of 60,000 to 120,000 people in a given area may be indicated by a first color whereas a population density between 0 to 60,000 people may be indicated by a second color on the map display.

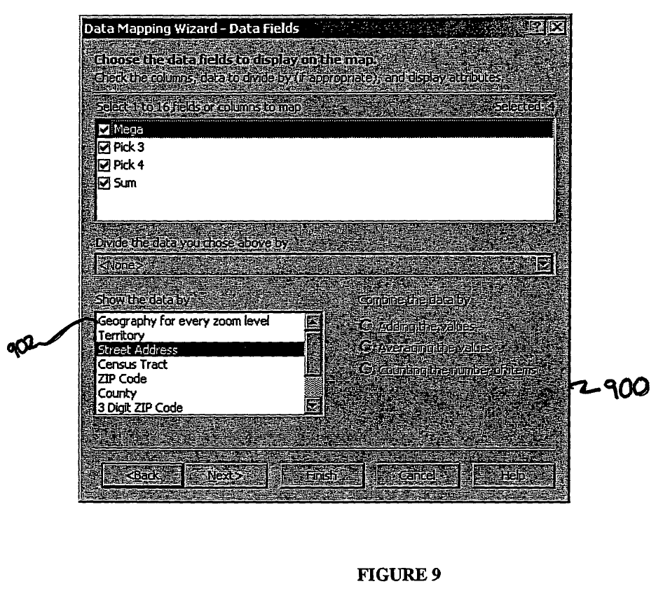

As shown in the configuration display 900 of FIG. 9, in some embodiments the mapping configuration function may also be used to map sales data other than the retailer location. As described above and shown in FIG. 3, the sales data also represent, for example, lottery sales per game for a defined period of time. As shown in FIG. 9, the “Mega,” “Pick 3,” “Pick 4” and “Summary” sales data associated with the individual retailers are selected for identification on a map display. The user is also provided the opportunity to define at what level the sales data should be mapped. For example, mapping to the “street address” level takes the sales data and maps it for each respective retailer location on the map. Mapping the sales data by “zip code” would map the data by zip code. If the data is imported as individual retailer sales data as described above, the sales numbers for each retailer in each zip code are summed to calculate the sales data for each zip code for mapping purposes. It is contemplated that other geographic selections may be made by the user as shown, for example, by the selection window 902 of FIG. 9.

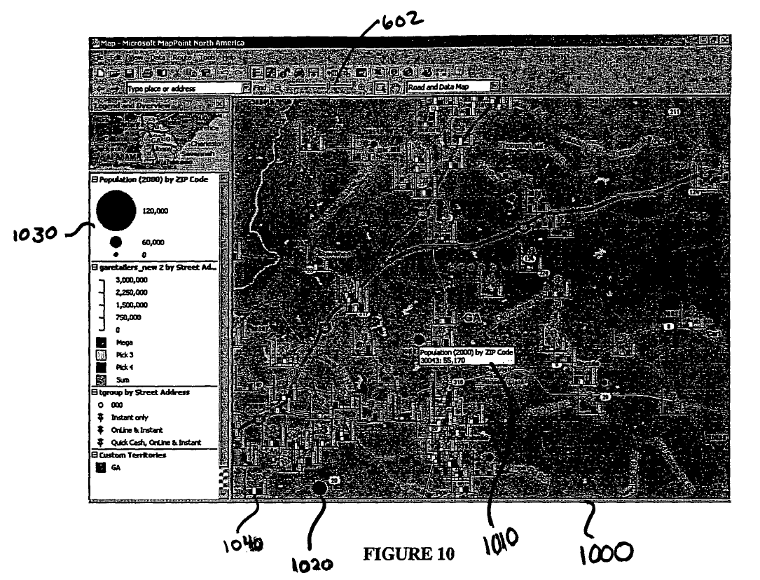

As shown by the map display 1000 of FIG. 10, the software mapping function then causes any data selected for mapping (using the Data Mapping Wizard Feature, for example) to be identified on the map display. As shown in the display 1000 of FIG. 10, the population (here, “55,170”) for the zip code (here, “30043”), as instructed to be mapped via the display of FIG. 8, is shown. The pop-up window 1010 is displayed when the user moves a pointer (e.g., a mouse arrow) over a particular region of the map display. Population densities are shown by the location of marks 1020 (as defined in legend 1030) on the map display 1000. Likewise, the retailer locations for the zoomed region are identified by their respective icons, as instructed via FIG. 4.

The game specific sales data as instructed via the interface 900 of FIG. 9 is also shown on the map. In one embodiment, the sales data are shown in the form of bar graph thumbnail images 1040 shown adjacent to the respective locations of the retailers.

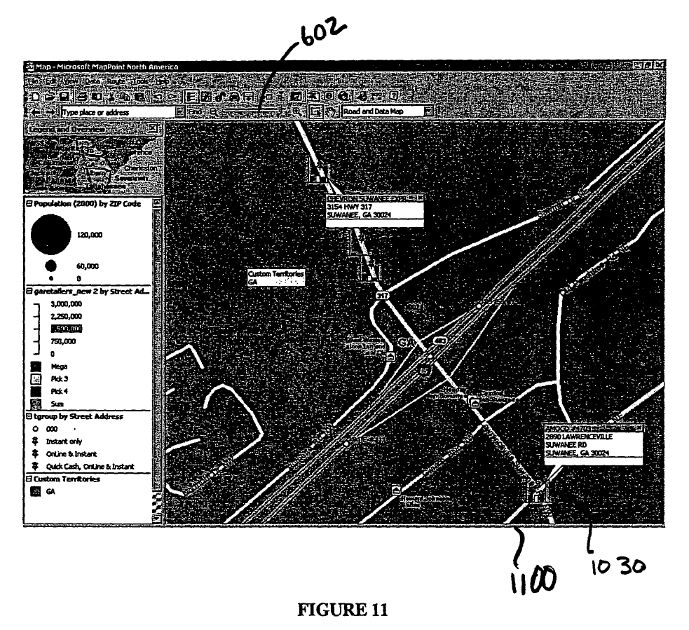

As shown in the map display 1100 of FIG. 11, using the “zoom” feature 602 enables the user to take a closer look at a specific area and the sales or other data associated with respective retailers. The street locations of retailers are shown along with their respective sales figures. Closer views of these figures can be obtained by simply zooming in on an area. Moving a pointer, such as a mouse pointer, over thumbnail images on the map display provides access to the raw sales data (e.g., dollar values) (not shown) in the form of pop-up window. Selecting a graph 1040 (e.g., by “clicking” on it) provides an enlarged view (not shown) for review.

Additional data may also be displayed on the map display. Other businesses or entities defined by the user may be identified, such as the location of hotels, e.g., “Howard Johnson Suites.” These locations and identities are obtained as described above by importing the relevant data and instructing the software package (e.g., MapPoint software) via the mapping configuration interface (e.g., Data Mapping Wizard feature) to identify the data on a map display. In this manner, a user can map non-retailers on a map display along with actual retailers. Distances between locations can also be measured by the software.

In some embodiments, the method and system enable a user to map both retailers and non-retailers of the lottery games in an area, such as all convenience stores. The user can then use the map display to help evaluate whether the community can support another retailer license and for which lottery games. Educated decisions can be made as to where retailers may be needed and where licenses should be revoked based in part on the geographic proximity of existing retailers, their sales numbers, the availability of businesses that could be retailers in the area, and/or population and demographic information such as numbers of persons in the area, their education and financial status, and their average age, just to name a few criteria for consideration.

In some embodiments of the system, the mapping software package, such as MapPoint software, also includes a routing feature that may prove particularly helpful to sales and marketing representatives that make field visits and delivery persons or distributors of instant ticket products. A route may be defined between a plurality of mapped retailers; then, mileage, gas expenses and other information are provided to the user in a display (not shown). This capability is built into the MapPoint software package. This feature should prove especially helpful for wearhousers of instant lottery tickets. Delivery of these tickets involves significant security issues and delivery route planning.

In one embodiment, the system also includes a voice recognition server utilizing natural language voice recognition technology. Voice recognition servers are available from such companies as VoiceGenie Technologies Inc. of Toronto, Ontario, Canada, IBM Corporation of Armonk, N.Y. and Nuance Communications of Menlo Park, Calif. When a sales person visits a retailer, the sales person places a call into the voice server, which has access to the sales data. The sales person can specify the retailer, and the voice server then recognizes the retailer and retrieves sales data for the retailer from a data storage unit 106. The sales data can then be read to the sales person using a text to speech translation, or the sales data may be directed to the mobile user terminal of the sales person for review. Similar functionality can be achieved using voice responsive systems, also known as Interactive Voice Response (IVR) systems.

The embodiments of the system and method described above provide several tools for a lottery administrator and/or ticket distributor. First, the system can be used for sales analysis on several different geographical scales. Second, the system may be used in developing marketing plans by utilizing the combination of sales data and population and demographic data to determine the specific interests of selected communities in lottery games and what are the purchasing tendencies of these communities. Third, the system can be used in the delivery of tickets or conducting field visits to map delivery routes, calculate distances, travel times, gas usage, and overtime expenses, for example, particularly for field visits and distribution of instant tickets. Fourth, the system can be used to analyze and evaluate where new retailers may be located, where to locate a new retailer to replace an under performing retailer, or which licenses of underperforming retailers to revoke. Currently, there is no concrete method of making such decision, or map-based system for providing the necessary information to the decision maker. The system enables the evaluator to examine distances between communities and retailers, the number of retailers in a community, which retailers are successful, the sales figures of those retailers, community demographics and the like and whether a new retailer in a specific location is likely to adversely affect existing retailers. By importing traffic information, the system may help identify potential retailer locations that could benefit from this traffic, especially in highways rest areas and gas stations.

The present invention can be embodied in the form of methods and apparatus for practicing those methods. The present invention can also be embodied in the form of program code embodied in tangible media, such as floppy diskettes, CD-ROMs, DVD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention

What is claimed is:

1. A computer-implemented method for processing lottery sales data, comprising the steps of:
(a) assigning unique identifiers to a plurality of lottery retailers, said unique identifiers indicating types of lottery games sold by respective lottery retailers from said plurality of lottery retailers; and
(b) identifying on a map display on a computer using said unique identifiers respective locations of lottery retailers from said plurality of lottery retailers.

2. The method of claim 1, further comprising the step of identifying on said map display lottery sales data for at least one identified retailer.

3. The method of claim 2, wherein said lottery sales data represent total sales for a selected time period of the types of lottery games sold by the at least one identified retailer.

4. The method of claim 1, further comprising the step of identifying on said map display an indication of a location of at least one non-lottery retailer.

5. The method of claim 4, further comprising the step of, after the step of identifying on said map display an indication of a location of at least one non-lottery retailer, utilizing information discerned from said map display in making a retailer decision.

6. The method of claim 1, further comprising the step of identifying on said map display demographic data for a geographic region shown on said map display.

7. The method of claim 6, further comprising the step of, after identifying on said map display demographic data for a geographic region shown on said map display, utilizing information discerned from said map display in making a lottery game marketing decision.

8. The method of claim 6, wherein said demographic data include population data.

9. The method of claim 6, wherein said demographic data include population income data.

10. The method of claim 1, further comprising the step of identifying on said map display a street address for at least one identified retailer.

11. The method of claim 1, further comprising the step of automatically generating travel data representing a trip to at least one identified retailer.

12. The method of claim 11, wherein said travel data represent a travel route to said at least one identified retailer, travel distance, travel time, gas usage, overtime expenses or a combination thereof.

13. The method of claim 11, wherein said travel data represents a travel route to said at least one identified retailer, said method further comprising the steps of utilizing said travel route in determining a travel route for delivering instant tickets to said one or more retailers.

14. A computer-implemented method for processing lottery sales data, comprising the steps of:
(a) identifying on a map display on a computer a location of at least one lottery retailer from a plurality of lottery retailers; and
(b) identifying on said map display lottery sales data respective to said at least one lottery retailer representative of lottery sales by said at least one lottery retailer for a selected period of time.

15. The method of claim 14, wherein said lottery sales data represent lottery sales according to lottery game type.

16. The method of claim 15, wherein said lottery sales data represent total sales for said selected time period of the types of lottery games sold by the respective lottery retailers.

17. The method of claim 14, further comprising the step of, after step (b), utilizing information discerned from said map display in making a retailer decision.

18. The method of claim 17, further comprising the step of identifying on said map display an indication of a location of at least one non-lottery retailer.

19. The method of claim 14, further comprising the step of identifying on said map display demographic data for a geographic region shown on said map display.

20. The method of claim 19, wherein said demographic data include population data.

21. The method of claim 19, wherein said demographic data include population income data.

22. The method of claim 19, further comprising the step of, after identifying on said map display demographic data for a geographic region shown on said map display, utilizing information discerned from said map display in making a lottery game marketing decision.

23. The method of claim 14, further comprising the step of identifying on said map display a street address for said at least one identified retailer.

24. A computer-implemented system for processing lottery sales data, comprising:
(a) means for assigning unique identifiers to a plurality of lottery retailers, said unique identifiers indicating types of lottery games sold by respective lottery retailers from said plurality of lottery retailers; and
(b) means for identifying on a map display on a computer using said unique identifiers respective locations of lottery retailers from said plurality of lottery retailers.

25. The system of claim 24, further comprising means for identifying on said map display lottery sales data for at least one identified retailer.

26. The system of claim 25, wherein said lottery sales data represent total sales for a selected time period of the types of lottery games sold by the respective lottery retailers.

27. The system of claim 24, further comprising means for identifying on said map display an indication of a location of at least one non-lottery retailer.

28. The system of claim 27, further comprising means for identifying on said map display demographic data for a geographic region shown on said map display.

29. The system of claim 28, wherein said demographic data include population data, population income data or a combination thereof.

30. The system of claim 24, further comprising means for identifying on said map display a street address for at least one identified retailer.

31. The system of claim 24, further comprising the means for automatically generating travel data representing a trip at least one identified retailer.

32. The system of claim 31, wherein said travel data represent a travel route to said at least one identified retailer, travel distance, travel time, gas usage, overtime expenses or a combination thereof.

33. A computer-implemented system for processing lottery sales data, comprising:
(a) means for identifying on a map display on a computer a location of at least one lottery retailer from a plurality of lottery retailers; and
(b) means for identifying on said map display lottery sales data respective to said at least one lottery retailer representative of lottery sales by said at least one lottery retailer for a selected period of time.

34. The system of claim 33, wherein said lottery sales data represent lottery sales according to lottery game type.

35. The system of claim 34, wherein said lottery sales data represent total sales for said selected time period of the types of lottery games sold by the respective lottery retailers.

36. The system of claim 33, further comprising means for identifying on said map display an indication of a location of at least one non-lottery retailer.

37. The system of claim 33, further comprising means for identifying on said map display demographic data for a geographic region shown on said map display.

38. The system of claim 37, wherein said demographic data include population data.

39. The system of claim 37, wherein said demographic data include population income data.

40. The system of claim 33, further comprising means for identifying on said map display a street address for said at least one retailer.
